(19) United States
(12) Patent Application Publication
(10) Pub. No.: US 2012/0070902 A1
(43) Pub. Date: Mar. 22, 2012

(54) METHOD FOR ANALYSIS OF SUGAR CHAINS BY MASS SPECTROMETRY

(75) Inventors: Hideyuki SHIMAOKA, Kobe-shi (JP); Midori ABE, Kobe-shi (JP); Kota IGARASHI, Yokohama-shi (JP)

(73) Assignee: SUMITOMO BAKELITE CO., LTD., Shinagawa-ku (JP)

(21) Appl. No.: 13/238,727

(22) Filed: Sep. 21, 2011

(30) Foreign Application Priority Data
Mar. 18, 2010 (JP) P2010-062174

(51) Int. Cl. G01N 27/72

(52) U.S. Cl. 436/94

(57) ABSTRACT

Provided is a highly accurate means for analyzing a sugar chain contained in a biological sample by MALDI-TOF MS or such a mass spectrometry method. In the present invention, it was found to be possible to improve the ionization efficiency of a sugar chain by methylating the hydroxyl groups of the sample sugar chain before conducting the MALDI-TOF MS analysis, and by so doing to carry out quantitative analysis and structural analysis of the sample sugar chain with high accuracy.

### TECHNICAL FIELD

The present invention relates to a method for analyzing a sugar chain contained in a biological sample by mass spectrometry.

### BACKGROUND ART

Sugar chain is a general term for molecules composed of monosaccharides such as glucose, galactose, mannose, fucose, xylose, N-acetylglucosamine, N-acetylgalactosamie, and sialic acid, and derivatives of them, linked via glycoside bonds to give a chain form.

Sugar chain is a substance which is diversified over a broad range, and takes part in various functions owned by naturally-occurring lives. The sugar chain often exists in vivo by binding to a protein or lipid in a form of glycoconjugate, which is one of the important constituents of living bodies. It has increasingly been revealed that sugar chains in living bodies are deeply associated with intercellular signaling, and regulation on protein functions and interactions.

For example, sugar chain-including biopolymers can be exemplified by proteoglycans in plant cell walls which are contributive to stabilization of cells, glycolipids which are affective to differentiation, proliferation, adhesion, migration, or such an event of cells, and glycoproteins which are associated with intercellular interaction and cell recognition. Mechanisms how sugar chains of these biopolymers control biological reactions in a sophisticated and precise manner, while mutually substituting, assisting, enhancing, regulating, or inhibiting their functions, have gradually been revealed. If associations of such sugar chains with differentiation and proliferation of cells, cell adhesion, immunity, and cancerization of cells are elucidated, a new development can be expected to be planned by closely relating this sugar chain engineering with medical science, cell engineering, or organ engineering (Non-Patent Document 1).

For the purpose of early detection of diseases to keep up a better quality of life (QOL), biomarkers which enable the prevention against the onset of diseases and the diagnosis on the development of diseases are necessary. From analytical studies on gene-disrupted mice lacking a sugar transferase that is responsible for the biosynthesis of sugar chains, it has been revealed that sugar chains are indispensable for the maintenance of functions of various kinds of tissues and organs (Non-Patent Documents 2 and 3). It has also been known that abnormal modifications of sugar chains may be causative of various diseases (Non-Patent Document 4). Since the structures of sugar chains may be distinctively different depending on cancerization of cells and various diseases, sugar chains are expected to be utilized as biomarkers for investigating the development of diseases.

MALDI-TOF MS is capable of easy and quick analysis without the need of complicated preparation of samples, and thus is considered to be a strong tool for searching biomarkers in recent years (Patent Documents 1 to 3). However, one of the tasks is to improve the sensitivity of the sugar chain analysis performed by MALDI-TOF MS.

### REFERENCES

### [Patent Document]

Patent Document 1: Japanese Unexamined Patent Application, First Publication No. 2009-142238

Patent Document 2: Japanese Unexamined Patent Application, First Publication No. 2009-216609

Patent Document 3: Japanese Unexamined Patent Application, First Publication No. 2009-229426

### [Non-Patent Document]

Non-Patent Document 1: Introduction to Glycobiology First Edition, Published 1 Nov. 2005 by Kagaku-Dojin Publishing Company, INC.

Non-Patent Document 2: Ioffe E., Stanley P., Proc. Natl. Acad. Sci., 91, pp. 728-732 (1994)

Non-Patent Document 3: Metzler M., Gertz A., Sarker M., Schachter H., Schrader J. W., Marth J. D., EMBO J., 13, pp. 2056-2065 (1994)

Non-Patent Document 4: Powell L. D., Paneerselvam K., Vij R., Diaz S., Manzi A., Buist N., Freeze H., Varki A., J. Clin. Invest., 94, pp. 1901-1909 (1994)

### DISCLOSURE OF INVENTION

The present invention was made by taking such situations into consideration, with an object of providing a highly sensitive method for analyzing a sugar chain contained in a biological sample by MALDI-TOF MS or such a mass spectrometry method.

The inventors of the present invention have pondered a problem that: because a sugar chain is a high-polarity and neutral material which includes many hydroxyl groups, the ionization efficiency is low for conducting mass spectrometry, thus lowering the accuracy of mass spectrometry if conducted. In order to solve this problem, they have conducted intensive studies. As a result, they have discovered that it is possible to improve the ionization efficiency of a sugar chain by methylating the hydroxyl groups of the sample sugar chain before conducting the MALDI-TOF MS analysis, and it is possible by so doing to carry out quantitative analysis and structural analysis of the sample sugar chain with high sensitivity. This has led to the completion of the present invention.

In other words, the present invention relates to a method for analyzing a sugar chain contained in a biological sample by a mass spectrometry method after methylating the hydroxyl groups of the sugar chain, and more concretely speaking, the present invention is to provide the following aspects.

[1] A method for analyzing a sugar chain contained in a biological sample by a mass spectrometry method, characterized by including:
(a) a step of releasing the sugar chain from the biological sample;
(b) a step of capturing the released sugar chain onto a solid phase carrier;
(c) a step of re-releasing the captured sugar chain;
(d) a step of methylating hydroxyl groups of the re-released sugar chain; and
(e) a step of analyzing the methylated sugar chain by the mass spectrometry method.
   [2] A kit for conducting the method according to [1], characterized by including a reagent for methylating hydroxyl groups of the sugar chain.

The present invention enables highly sensitive analysis of a sugar chain contained in a biological sample by using MALDI-TOF MS. Moreover, when a sugar chain having its hydroxyl groups methylated has been cleaved by acid hydrolysis or the like, hydroxyl groups are generated at the cleaved sites only. Therefore, the present invention also enables analyses of the cleaved sites and the form of the linkage of the sugar chain.

### BRIEF DESCRIPTION OF THE DRAWINGS

FIG. 1 shows the result of MALDI-TOF MS analysis on N-linked sugar chains of bovine serum IgG.

### BEST MODE FOR CARRYING OUT THE INVENTION

(Step of Releasing Sugar Chain from Biological Sample)

The sugar chain-containing sample used in the present invention may be prepared from biological samples such as whole blood, serum, plasma, urine, saliva, cell, tissue, virus, and plant tissue. Alternatively, also those prepared from purified or unpurified glycoproteins may be adoptable. The sample may be pretreated by degreasing, desalting, protein fractionation, heat denaturation, or such a method.

Sugar chains are released from glycoproteins contained in the above-mentioned biological sample, by using a means of releasing sugar chains. The means of releasing sugar chains adoptable herein may be exemplified by a glycosidase treatment using N-glycosidase or O-glycosidase, hydrazine decomposition, β elimination under an alkaline treatment, and so forth. When analyzing N-type sugar chains, it is preferable to adopt a method using N-glycosidase. A protease treatment using trypsin, chymotrypsin, or the like, may also be conducted prior to the glycosidase treatment.

### (Step of Capturing Released Sugar Chain Onto Solid Phase Carrier)

The solution containing the sugar chains is contacted with a trap carrier which is specifically bindable to sugar chains, thereby capturing the sugar chains onto the trap carrier.

Sugar chain is only a substance which has aldehyde groups, among biological substances. In other words, a sugar chain is present in the equilibrium between the cyclic hemiacetal form and the non-cyclic aldehyde form in an aqueous or such a condition. Biological substances other than sugar chains such as proteins, nucleic acids, and lipids do not have an aldehyde group. From this fact, it is possible to selectively capture only sugar chains by utilizing a trap carrier that has a functional group which can specifically react with an aldehyde group to form a stable bond. Preferred examples of such a functional group which can specifically react with an aldehyde group can be given by an oxylamino group, a hydrazide group, an amino group, a semithiocarbazide group, and derivatives thereof. More preferred are a hydrazide group and an oxylamino group. Since an oxime bond generated by the reaction between an oxylamino group and an aldehyde group, and a hydrazone bond generated by the reaction between a hydrazide group and an aldehyde group, can be easily cleaved by an acid treatment or the like, the sugar chain can be readily cleaved and separated from the carrier after being captured thereto. In general, an amino group is often employed for capturing and retaining physiologically active substances. However, the binding strength of the bond generated by the reaction between an amino group and an aldehyde group (Schiff base) is weak, and thus a secondary treatment using a reductant or such an agent is necessary. Therefore, an amino group is not preferable for capturing sugar chains.

It is preferable to adopt polymer particles as a carrier for capturing sugar chains. The polymer particles are preferably solid or gel particles having a functional group which can specifically react with an aldehyde group of a sugar chain at least on a part of the particle surface. If the polymer particles are solid or gel particles, the sugar chain can be readily recovered by centrifugation, filtration, or such a means, after being captured onto the polymer particles. In addition, it is also possible to adopt a column filled with such polymer particles. The method to use a column filled with the particles is important particularly for the purpose of continuously carrying out the operations. The use of a filter plate (exemplified by MultiScreen Solvinert Filter Plate, a product of Millipore) as a reaction vessel makes it possible to simultaneously handle a plurality of samples, and to remarkably improve, for example, the throughput of the purification of the sugar chain as compared to a conventional purification means which uses gel filtration or such column operations.

The shape of the polymer particle is not specifically limited, although preferred are globular or similar shapes. In the case where the polymer particles are globular, the mean particle diameter is preferably from 0.05 to 1000 μm, more preferably from 0.05 to 200 μm, yet more preferably from 0.1 to 200 μm, and most preferably from 0.1 to 100 μm. If the mean particle diameter is under the lower limit, it is necessary to apply a large pressure when using a column filled with polymer particles, because it is difficult for the liquid to pass through. In addition, it is also difficult to recover these polymer particles by centrifugation or filtration. If the mean particle diameter is over the upper limit, the area of contact between the polymer particles and the sample solution is small, and thus the efficiency of capturing sugar chains is lowered. In the present invention, “BlotGlyco®” (#BS-45603, a product of Sumitomo Bakelite Co., Ltd) which is hydrazide group-containing polymer particles can be suitably adopted.

The pH of the reaction system for capturing sugar chains with use of the polymer particles which can specifically capture the sugar chains is preferably from 2 to 9, more preferably from 2 to 7, and yet more preferably from 2 to 6. Various types of buffer solutions can be used for the pH adjustment. The temperature for capturing sugar chains is preferably from 4 to 90° C., more preferably from 4 to 70° C., yet more preferably from 30 to 80° C., and most preferably from 40 to 80° C. The reaction time can be appropriately set. It is also possible to use a column filled with the polymer particles so that the sample solution can pass through.

In the case of using polymer particles, impurities other than sugar chains should be removed by washing as they are non-specifically adsorbed on the carrier surface. Regarding the washing liquid, it is preferable to adopt an appropriate combination of water, a buffer solution, water or a buffer solution containing a surfactant, an organic solvent, or the like. A particularly preferred embodiment is a method having processes of: sufficiently washing with water or a buffer solution containing a surfactant, thereafter washing with an organic solvent, and lastly washing with water. By applying these washing processes, non-specifically adsorbed substances are removed from the surfaces of the polymer particles.

The excessive portion of the functional group on the carrier can be capped, for example, by using acetic anhydride or the like.

### (Step of Re-Releasing Captured Sugar Chain)

Next, the sugar chains bound to the polymer particles serving as the trap carrier are re-released to obtain a purified sugar chain sample.

Here is a description of the step of substituting the sugar chain binding to the polymer particle with a different compound (hereunder, may be referred to as “compound A”). It is preferable that the compound A is a labeling reagent. The substitution can be carried out by adding an excessive amount of the compound A relative to the amount of the polymer particles binding to the sugar chains. In other words, the sugar chain is cleaved and separated from the polymer particle, and at the same time the compound A is attached to the sugar chain (the sugar chain is “labeled” with A). The amount of the compound A to be excessively added is preferably 1.5 times or more, more preferably 3 times or more, yet more preferably 5 times or more, and most preferably 10 times or more, than the amount of the functional group which can specifically react with the sugar chain held by the polymer particle. The pH of the reaction system is preferably from 2 to 9, more preferably from 2 to 7, and yet more preferably from 2 to 6. Various types of buffer solutions can be used for the pH adjustment. The temperature of the reaction system is preferably from 40 to 90° C., and more preferably from 40 to 80° C. It is preferable that the solvent be evaporated upon the completion of this step.

It is preferable that the compound A is a compound having an aminooxy group or a hydrazide group. The most preferred compound is N-aminooxyacetyl-tryptophanyl (arginine methyl ester). This compound is commercially available as a re-releasing agent appended to the above-mentioned product “BlotGlyco® for MALDI” (#BS-45603, a product of Sumitomo Bakelite Co., Ltd).

Until here has been a description of the method to obtain the labeled sample by releasing the sugar chains captured onto the sugar chain-trapping substance; however, it is also possible to obtain a non-labeled sample in accordance with a method that will be described below. The present invention also provides this kind of sample preparation method. This sample preparation method is characterized in treating the polymer particles binding to the sugar chains under an acidic condition to thereby dissociate the hydrazone bond so as to release the sugar chains. The treatment under the acidic condition in this case means a treatment with a 0.01 to 20 volume percent acetic acid solution, and preferably a 0.1 to 5 volume percent acetic acid solution, at 40 to 80° C. for 5 to 60 minutes. It is preferable that the solvent be evaporated upon the completion of this step.

### (Step of Methylating Hydroxyl Groups of Re-Released Sugar Chain)

Next, hydroxyl groups of the re-released sugar chains are methylated. The methylating reagent can be exemplified by iodomethane. The dose of the methylating reagent is preferably from 10 to 200 μL, and more preferably from 10 to 100 μL. Preferred is a mixed solution of the methylating reagent and dimethyl sulfoxide (DMSO), and more preferred is a NaOH/DMSO slurry. Here, the term “NaOH/DMSO slurry” means a mixture in which pulverized solid NaOH is dispersed in DMSO.

The methylating reagent solution is added to the polymer particles upon the completion of the above-mentioned step of re-releasing the sugar chains. The mixture is then left still at a predetermined temperature for a predetermined period of time, to thereby effect the methylation of the sugar chains. This methylation step is usually carried out at 10 to 60° C., and preferably at 10 to 40° C., for 10 minutes.

The methylation reaction can be stopped by adding pure water. The methylated sugar chains can be recovered from the reaction solution, for example, through chloroform extraction. For example, it is possible to recover the methylated sugar chains by adding the reaction solution after the methylation reaction to chloroform, then collecting the chloroform layer, washing it with pure water, and thereafter evaporating the chloroform solution, and to adopt the thus recovered sugar chains for the mass spectrometry that will be described later.

As mentioned above, according to the method of the present invention, there is no need of separating the re-released sugar chains from the polymer particles, and it is possible to conduct the methylation while the sugar chains and the polymer particles are mixedly present. In addition, since the methylation reaction should be done without the presence of water, it is usual to dry the sugar chain solution by lyophilization or such a method before use for the reaction. However, the method of the present invention does not require such a drying process because the solvent has been evaporated after the completion of the step of re-releasing the sugar chains. In this way, the present invention provides a method for performing purification and methylation of sugar chains with easy and simple manipulations.

### (Step of Analyzing Methylated Sugar Chain by Mass Spectrometry Method)

The obtained sugar chains can be analyzed by MALDI-TOF MS or such a mass spectrometry method. The mass spectrum obtained from the MALDI-TOF MS analysis can be analyzed by using an analysis software or the like. The peaks of the sample sugar chains are detected by reading the mass-to-charge ratio (m/z value). The quantification and the structural analysis of each sugar chain can be conducted on the basis of the mass-to-charge ratio and the peak intensity (the height of the peak, the area of the peak, or any given index). Various types of databases (for example, GlycoMod, Glycosuite, and the like) are available for the analysis of sugar chains.

### (Kit)

The present invention provides a kit for conducting the above-mentioned method of the present invention, characterized by including a reagent for methylating hydroxyl groups of a sugar chain. The kit of the present invention can include, in addition to the methylating reagent, for example, (1) a carrier (such as beads) for capturing (purifying) the sugar chain, (2) a reagent for labeling and/or re-releasing the sugar chain captured onto the carrier, (3) a carrier (such as a column) for removing an excessive portion of the reagent (2) remaining in the reaction solution, (4) a tube for the reaction, and (5) usage instructions.

### EXAMPLES

Hereunder is a more specific description of the present invention with reference to Examples. However, the present invention is not to be limited by the Examples shown below.

### Example 1

### Release of Sugar Chains From Glycoproteins

One milligram of bovine serum immunoglobulin G (IgG #I5506, a product of Sigma-Aldrich) was placed in a tube. Then, an aqueous solution of 1 M ammonium bicarbonate (5 μL), pure water (50 μL), and an aqueous solution of 120 mM dithiothreitol (5 μL) were added thereto. The mixture was completely dissolved and then incubated at 60° C. for 30 minutes. Next, an aqueous solution of 123 mM iodoacetamide (10 μL) was added thereto. The tube was shielded from light and left still at room temperature for 1 hour. Then, the mixture was added with 400 units of trypsin and left still at 37° C. for 1 hour. The mixture was then heated at 95° C. for 5 minutes to thereby deactivate the trypsin. Thereafter, the mixture was added with 5 units of N-glycosidase F (#11365193001, a product of Roche Diagnostics) and left still at 37° C. for 16 hours. By so doing, sugar chains were released.

### Example 2

### Retention of Sugar Chains Onto Polymer Particles

20 μL of the thus obtained solution of the released sugar chains (equivalent to 100 μg of IgG) was added to 5 mg of polymer particles (#BS-45603, a product of Sumitomo Bakelite Co., Ltd), and 180 μL of acetonitrile containing 2% acetic acid was added thereto. Thereafter, the mixture was allowed to react at 80° C. for 1 hour, and solidified by drying. The polymer particles were washed with a 2 M guanidine hydrochloride solution, water, methanol, and a 1% triethylamine solution. Then, a 10% anhydrous acetic acid/methanol solution was added thereto, and the mixture was allowed to react at room temperature for 30 minutes, thereby capping the hydrazide groups. After the capping, the polymer particles were washed with methanol and water.

### Example 3

### Re-Releasing of Sugar Chains

The thus prepared sugar chain-retaining polymer particles were added with 20 μL of pure water and 180 μL of acetonitrile containing 2% acetic acid. Thereafter, the mixture was allowed to react at 80° C. for 1 hour, and solidified by drying. By so doing, the sugar chains were released from the polymer particles.

### Example 4

### Preparation of Methylating Reagent Solution

About 1 g of granular sodium hydroxide was placed in a mortar and quickly milled with a pestle. The milled sodium hydroxide was added with 1 mL of DMSO and mixed, thereby preparing a slurry-like solution. 100 μL of this solution and 100 μL of iodomethane (#131-02661, a product of Wako Pure Chemical Industries, Ltd) were then mixed. By so doing, a methylating reagent solution was prepared.

### Example 5

### Methylation of Sugar Chains

After the completion of the re-releasing of the sugar chains, the polymer particles were added with 100 μL of the methylating reagent solution. The mixture was allowed to react by leaving still at 25° C. for 10 minutes. Thereafter, the reaction was stopped by adding 200 μL of pure water. The polymer particles were separated from the solution by filtration, and the solution was collected. The solution was transferred into a sample tube, and 400 μL of chloroform was added thereto. The mixture was then agitated for 1 minute. By so doing, the methylated sugar chains were recovered in the chloroform layer. The sample tube was left still until the solution was separated into chloroform and water layers. The chloroform layer was then collected in a different sample tube. 800 μL of pure water was added thereto, and the mixture was agitated for 1 minute. By so doing, water soluble impurities contained in the chloroform layer were removed. The sample tube was left still until the solution was separated into chloroform and water layers. The chloroform layer was then collected in another different sample tube, and dried by a centrifugal drier, thereby obtaining methylated sugar chains.

### Example 6

### MALDI-TOF MS Analysis

The thus obtained methylated sugar chains were dissolved in 100 μL of methanol. This solution was diluted 10-fold with a matrix solution (aqueous solution of 10 mg/mL 2,5-dihydroxybenzoic acid). 1 μL of the diluted solution was spotted on a sample stage, and then dried to crystallize. The crystallized product was analyzed with a matrix assisted laser ionization time-of-flight mass spectrometry system (MALDI-TOF MS system) (“autoflex III”, a product of Bruker Daltonics). The analysis was performed in positive ion detection mode and reflectron mode.

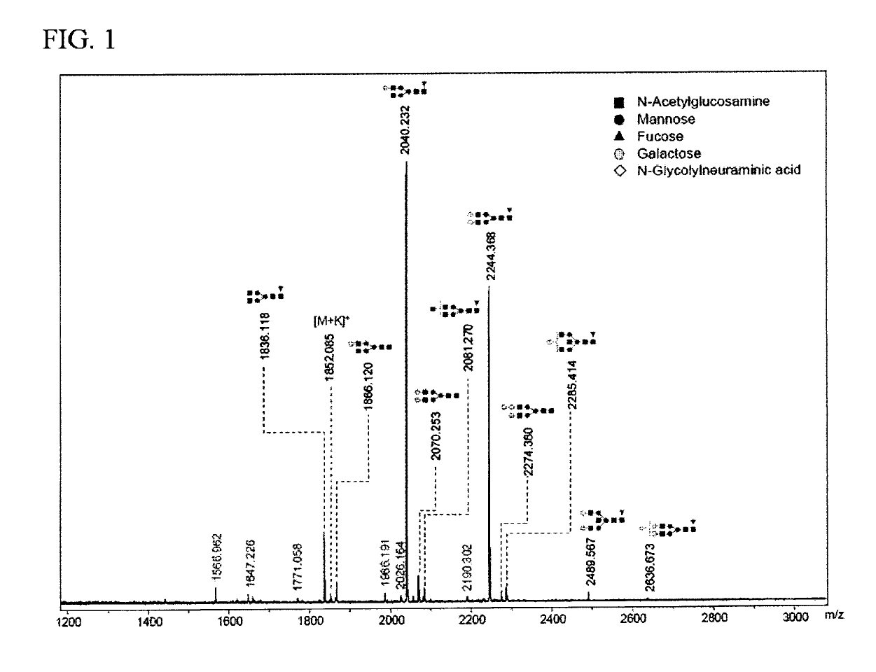

The resulting mass spectrum is shown in FIG. 1. The sugar chain composition was estimated from the mass-to-charge ratio (m/z value) given by the mass spectrum. The estimation of the sugar chain composition was done by using the GlycoMod tool (http://www.expasy.org/tools/glycomod/) and the GlycoSuite database (http://glycosuitedb.expasy.org/glycosuite/glycodb). The schematic diagrams of the estimated sugar chains are shown in the mass spectrum of FIG. 1.

As described above, it was shown to be possible, by conducting the MALDI-TOF MS analysis after methylating hydroxyl groups of a sample sugar chain, to carry out quantitative analysis and structural analysis of the sample sugar chain with high sensitivity.

### INDUSTRIAL APPLICABILITY

With use of the method for analyzing a sugar chain of the present invention, it is possible to carry out quantitative analysis (quantitative profiling) and structural analysis of a sugar chain of a glycoprotein contained in a biological sample, such as serum or tissue of a diseased patient, with high sensitivity. Thus, the present invention is applicable to the search for a sugar chain as a disease marker, the kinetic study on a sugar chain upon drug administration, and such medical fields.

1. A method for analyzing a sugar chain contained in a biological sample by a mass spectrometry method, characterized by including:
(a) a step of releasing the sugar chain from the biological sample;
(b) a step of capturing the released sugar chain onto a solid phase carrier;
(c) a step of re-releasing the captured sugar chain;
(d) a step of methylating hydroxyl groups of the re-released sugar chain; and
(e) a step of analyzing the methylated sugar chain by the mass spectrometry method.

2. A kit for conducting the method according to claim 1, characterized by including a reagent for methylating hydroxyl groups of the sugar chain.
